(19) United States
(12) Patent Application Publication
(10) Pub. No.: US 2019/0138667 A1
(43) Pub. Date: May 9, 2019

(54) SYSTEMS AND METHODS FOR THE DIGITAL VERIFICATION OF INDUSTRIAL CONSTRUCTION EXECUTION

(71) Applicant: Veerum Inc., Calgary (CA)

(72) Inventors: Scott Benesh, Calgary (CA); Steve Fisher, Black Diamond (CA); Amit Varma, Calgary (CA)

(21) Appl. No.: 16/184,850

(22) Filed: Nov. 8, 2018

Related U.S. Application Data
(60) Provisional application No. 62/583,289, filed on Nov. 8, 2017.

(51) Int. Cl. G06F 17/50; G06Q 10/06; G06Q 50/08

(52) U.S. Cl. CPC G06F 17/5004; G06F 2217/02; G06Q 50/08; G06Q 10/063

(57) ABSTRACT

Systems and methods are provided for managing a construction project using a digital twin or digital execution verification. A data ingestion module receives construction project data from data sources through a communication interface. An infrastructure module generates a digital twin of the construction project using a first data subset, and generates a plan model of the construction project using a second data subset. A display interface displays at least a portion of the digital twin overlaid with a corresponding portion of the plan model in a virtual environment. The plan model contains at least one planned component. The digital twin contains at least one construction component associated with a corresponding constructed component at a construction site. A construction mismatch is determined based on a comparison of the digital twin and the plan model, and is used to made adjustments for the construction project.

### REFERENCE TO RELATED APPLICATIONS

This application claims priority from U.S. Application No. 62/583,289 filed on Nov. 8, 2017 and entitled DIGITAL TWIN WORKFLOW. For purposes of the United States, this application claims the benefit under 35 U.S.C. § 119 of U.S. Application No. 62/583,289 filed on Nov. 8, 2017 and entitled DIGITAL TWIN WORKFLOW which is hereby incorporated herein by reference for all purposes.

### TECHNICAL FIELD

The present disclosure relates generally to computer-implemented systems and methods for construction project management.

### BACKGROUND

Industrial construction projects are highly complex with supply chains spanning multiple countries, dozens of contractors and thousands of workers.

Components and parts needed for the construction project are engineered, manufactured and fabricated all over the world and need to be assembled together at the construction site. Each phase of the construction process is interdependent; however, they are often performed in parallel through a process commonly referred as “concurrent engineering” in an effort to shorten the time required for project delivery. Any errors in one phase of the project can adversely affect the next phase if improperly communicated and addressed. When parts, modules and equipment arrive on site, the culmination of errors throughout the project lifecycle can result in the need for field welds and rework.

A certain amount of uncertainty, variability, inefficiency, and rework is typically budgeted for in engineering and construction projects. In some cases, uncertainty and variability may be budgeted for as a contingency representing 10% to 30% of the total project cost. Even with this contingency, projects are in general continuously over budget and over schedule. According to a 2017 study conducted by McKinsey & Company, so-called “mega projects” in excess of US$1 billion average 80% cost overruns and 20 month schedule delays. An article by Miri and Khaksefidi entitled “Cost Management in Construction Project: Rework and its Effects” report published in 2015 in the Mediterranean Journal of Social Sciences found that around 30% of the work performed by construction companies is actually rework. According to Love and Li in a 2000 article entitled “Quantifying the Ccauses and Costs of Rework In Construction” published in Construction Management and Economics, such rework in the construction industry is defined as the unnecessary effort of redoing a process or activity that was incorrectly implemented the first time. This need for rework therefore constitutes a significant risk and tremendous inefficiency to large industrial construction projects.

Project managers currently do not have good visibility into the on-site execution of their construction project. Different contractors use different systems to manage their work, which are inaccessible to other members of the project whose job relies on contractor performance. Critical information is spread across disparate systems and it is the job of the project manager to try and reconcile this information. The project manager wants to know how they are progressing according to their project plan. Questions that are raised include: What has happened? What went right? What went wrong? What issues need to be addressed? What is the overall progress? However, it is difficult to determine what information is accurate or reliable. The incentive structures built into industrial construction contracts favour the transfer of risk between project stakeholders. Each party has a responsibility to minimize their own risk, but this is often done at the expense of other project participants. When information is found to be incorrect or misinterpreted, it can have ramifications for the entire project and cultivate mistrust. Project stakeholders have to spend more time verifying data, invoices and information and may need to seek damages through claims management when discrepancies are identified.

Accordingly, there is a need for systems and methods that address or ameliorate the above-noted disadvantages.

### SUMMARY OF THE DISCLOSURE

In general, the present disclosure describes systems and methods for management of a large-scale construction project using a digital twin model or digital execution verification.

One aspect of the disclosure provides a system for management of a construction project, the system comprising a communication interface and a data ingestion module operable to receive data associated with the construction project from a plurality of data sources through the communication interface. The system comprises an infrastructure module operable to generate a digital twin of the construction project in a virtual environment using a first subset of the data, and generate a plan model of the construction project in the virtual environment using a second subset of the data. The system also comprises a display interface operable to display at least a portion of the digital twin overlaid with a corresponding portion of the plan model, wherein the plan model contains at least one planned component, and the digital twin contains at least one construction component associated with a corresponding constructed component at one of a manufacturing facility, fabrication yard, and a construction site.

In some embodiments, the first subset of the data corresponds to construction site data acquired at the construction site, and the second subset of the data corresponds to project planning data. At least the first subset of the data may contain geo-location data in a metadata field usable to determine a position of the at least one construction component within the virtual environment.

The infrastructure module is operable to determine a ground truth of the ingested data based on at least one image obtained of a survey monument having known coordinates. A construction mismatch is determined based on a comparison of the digital twin and the plan model in the virtual environment, wherein the construction mismatch constitutes at least one of a missing component mismatch and an out-of-tolerance mismatch. The display interface is configurable to display at least one of the digital twin, plan model, and overlay of the digital twin and plan model in at least one of a two-dimensional display mode, three-dimensional display mode, and a virtual reality display mode.

In particular embodiments, the first subset of data contains geo-location data in a metadata field. The system comprises a logistics service module to maintain a record to track the location and availability of at least one of tools, personnel, vehicles, transport systems, construction equipment, parts, components, sub-structures required for the construction project based on geo-location data contained in a metadata field of the first subset of the data.

Another aspect of the disclosure provides a method for management of a construction project, the method comprising receiving data associated with the construction project from a plurality of data sources, and generating a digital twin of the construction project in a virtual environment using a first subset of the data. The digital twin contains at least one construction component associated with a corresponding constructed component at a construction site. The method further comprises generating a plan model of the construction project in the virtual environment using a second subset of the data. The plan model contains at least one planned component. At least a portion of the digital twin is overlaid on to the plan model in the virtual environment.

In some embodiments, the first subset of the data corresponds to construction site data acquired at the construction site, and the second subset of the data corresponds to project planning data. At least the first subset of the data contains geo-location data in a metadata field usable to determine a position within the virtual environment for the digital twin. Overlaying the digital twin on the plan model comprises positioning the at least one construction component in spatial relation to a counterpart planned component of the at least one planned component within the virtual environment, the spatial relation being determinable based on the geo-location data associated with a physical location of the corresponding constructed component at one of a manufacturing facility, fabrication yard, and the construction site.

In particular embodiments, the method comprises determining a ground truth of the data based on at least one image obtained of a survey monument having known coordinates and adjusting the geo-location data based on the ground truth. The method comprises identifying construction mismatches by comparing the digital twin and the plan model in the virtual environment, wherein the construction mismatches constitutes at least one of a missing component mismatch and an out-of-tolerance mismatch.

According to some embodiments, the method comprises maintaining a record to track the location and availability of at least one of tools, personnel, vehicles, transport systems, construction equipment, parts, components, sub-structures required for the construction project based on geo-location data contained in a metadata field of the first subset of the data.

Additional aspects of the present invention will be apparent in view of the description which follows.

### BRIEF DESCRIPTION OF THE DRAWINGS

Features and advantages of the embodiments of the present invention will become apparent from the following detailed description, taken with reference to the appended drawings in which:

FIG. 1 is a block diagram of an automated digital twin model of truth (DTMT) system according to at least one embodiment;

FIGS. 2A and 2B (collectively, FIG. 2) and FIG. 3 are two-dimensional visualizations of reality data overlaid onto planned data as generated by the DTMT system of FIG. 1;

FIGS. 4 and 5 are two-dimensional reports showing a construction progress report as generated by the DTMT system of FIG. 1;

FIG. 6A is a three-dimensional visualization as generated by the DTMT system of FIG. 1;

FIG. 6B is a three-dimensional heat-map as generated by the DTMT system of FIG. 1;

FIG. 7 is a three-dimensional visualization showing a construction mismatch as generated by the DTMT system of FIG. 1; and

FIG. 8 is a chart illustrating a data capture method of a data capture plan according to one embodiment.

### DETAILED DESCRIPTION

The description which follows, and the embodiments described therein, are provided by way of illustration of examples of particular embodiments of the principles of the present invention. These examples are provided for the purposes of explanation, and not limitation, of those principles and of the invention.

One difference between commercial construction and industrial construction is the complexity, remoteness and the economics of the project. For example the construction of a skyscraper is relatively less complex since each floor above an initial first floor that is built on top of a foundation is essentially a replication of the floor below. Commercial construction can be built entirely from components obtainable from catalogues (cement, roofing, shingles, electrical wiring, etc.) and the economics make it most suitable to construct everything at the construction site.

Large-scale industrial construction, on the other hand, is relatively more complex. The design of the project may involve multiple engineering teams that may be scattered across the globe. Customized parts and modules are often manufactured in various parts of the world, and are sent to assembly yards for prefabrication in another location before being shipped to the construction site. Furthermore, large-scale industrial construction projects are often located at remote locations, each location with varying characteristics. For example, in the oil and gas industry, wells are often located in remote locations and each well often has different reservoir characteristics including pressure, product, and geology. Similarly, hydro dam construction projects must account for different flow rates, pressures, etc. unique to the site, resulting in no two hydro dams being the same. With this level of customized engineering and prefabrication, and coupled with a complex supply chain, quality assurance and quality control is important as all parts, equipment, and modules need to be bolt-up and fit perfectly when they arrive at the construction site. While individual errors at various stages of the project lifecycle may not seem significant, they accumulate into large errors at the construction site, resulting in field welds and rework, which ultimately lead to an increased cost of the overall construction project.

One potential source of inaccuracies is in the design. Specifically, an incorrect design may be caused by the inability to interface engineering designs of the new facilities with existing facilities during brownfield expansions. Under current practice, project initiation documents are largely created from memory while tie-in points and scopes of work are defined on paper. Designs are engineered based on manual surveys or out-dated as-builts which are often wrong. These as-builts can be two-dimensional drawings or three-dimensional CAD representations. However, both are often inaccurate and imprecise because the legacy project was not perfectly executed according to the plan and new retrofits may have been performed over the years without updating the as-built. Field fits and rework are accepted as a cost of the uncertainty. In an effort to reduce this uncertainty, engineers may be required to visit the physical site to perform a site survey, taking measurements and photographs. These additional steps may be expensive, time consuming, and may still result in errors in the design as the process relies on human effort which opens up opportunities to human error.

Current approaches to reducing inaccuracies in the designs can include incorporating site data using techniques such as laser scanning to digitally capture existing facilities. The scanned data is then integrated into the CAD design where the CAD design is fit within reality. The digital model generally resides within the engineering office and is locally worked on in isolation by the designer. There may be limitations as to who can use and access this digitized model.

Another potential source of inaccuracies is errors in manufacturing of parts and components, prefabrication, and assembly. For example, fabrication and assembly of various parts and elements used in the project may not fully meet the design specification and may not conform to the existing infrastructure tie ins. To address this source of inaccuracy, fabrication and assembly processes may incorporate quality control methods of manual measurement of the fabricated parts and manually comparing the parts against the design drawings. This quality control approach requires the design itself to be correct and the measuring method and practice to be correct. The largely manual practice introduces a high margin of error. The end result is a more expensive, time consuming endeavour that may still result in human QA/QC (Quality Assurance/Quality Control) error and errors in design.

While these fabricated parts can be measured using laser scanners, manual inspection to identify variances is still required. Sometimes, these variances are non-material on their own. However, the culmination of these variances throughout a construction project may compound into significant on-site rework.

Generally, all pre-fabricated modules bolt-up together according to specification when they arrive. To further ensure that the fabrication of the component parts is matched to the connecting parts, a trial-fit of the parts can take place at a location away from the construction site. This approach requires shipping the parts to a trial-fit site and assembling the parts to conduct the trial-fit, and then dissembling the parts at the trial-fit site prior to shipping the parts to the intended site. This method often requires large plots of land to carry out as well as increased logistics, time, and cost. Laser scanning of the fabricated part can sometimes be performed to digitally capture the part. The digitized part can be overlaid with a CAD design of the same part to enable manual inspection to identify any variances. Inefficiencies in the construction project can result from incorrect placement or allocation of components and tools required for the construction project. For example, components or tools that are needed at the construction site, fabrication facility or assembly yard may not be available because someone has moved them or they are stored elsewhere, thereby causing delays. Procurement functions may include logistics services to track the location of various components. The tracking of components can be carried out manually by way of spreadsheet tracking with the use of shipping packing lists, shipping company reports, receiving reports, warehousing reports, etc. The tasks can include manually matching the plan of where components are required (the plan) to where they actually are (reality) and identify mismatches. Given that this is a largely manual exercise, it imposes a high cost and a high margin of error can be present when various complex tracking systems are used together. This endeavour may be expensive, time consuming, and may still result in errors in design as it relies on significant human effort and time delays in reporting.

The tracking process can be complemented using various forms of technologies such as tagging assets with Radio Frequency Identification (RFID) devices and Global Positioning System (GPS) to assist in the verification of the location of components. For example, an RFID tag can be applied to a component to enable the component to be “read” by a local RFID tag reader (e.g. handheld or stationary) to confirm the component's location. The RFID tags can be passive tags, which require that the local reader be positioned sufficiently close to the tag to read it. As an alternative to passive tags, active tags may be used to transmit an identifying signal that may be received by a receiver using Wi-Fi (IEEE 802.11 wireless local area networking) technologies, mobile telecommunication networks, or satellite. The active RFID tags may provide real-time location tracking. Nevertheless, the use of active tags may still require manual integration of the tags into the tracking system.

Another source of inefficiencies is incorrect project progress reporting. Specifically the extent of completion of a project (e.g. expressed as a percentage progress) may not be accurately reported, as it is a subjective measure reported by humans performing the work. Generally, most contractors are incentivized over state progress and may hide schedule delays to ensure timely payments according to plan. This impedes scheduling stewardship. Current solutions primarily rely on a manual practice of subjective reporting. For example, an assigned personnel or a quantity surveyor is tasked with manually confirming that a particular task in the construction project has been completed. Once confirmed, data indicating completion of the task is manually entered into a tracking system, such as a computerized tracking program. The program may then calculate the actual progress and measure it against the planned progress. There are drawbacks to such a method. Manual progress reports are often based on whether something was installed or not. This falsely assigns completion to a task which may have been performed incorrectly and needs to be reworked. For example, in some cases, a component that has not been installed according to specification (e.g. outside of set tolerance ranges) should not be considered to have been properly installed. Additionally, the construction owner is often reliant on accurate progress reports from all its sub-contractors and vendors. These progress reports are often skewed in favor of the subcontractor as they are paid for the work completed. Assessing the validity and trustworthiness of these progress reports can therefore be challenging, Progress reporting carried out in the described manner is understood to have an estimated margin of error of up to 30%. Furthermore, since data entry is carried out manually, this process is labour intensive.

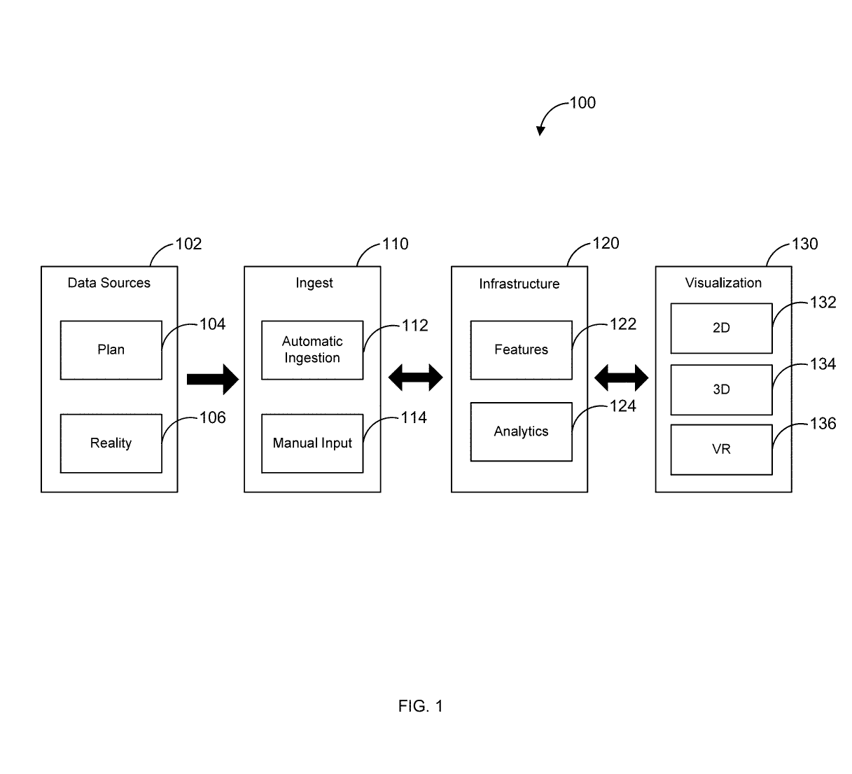

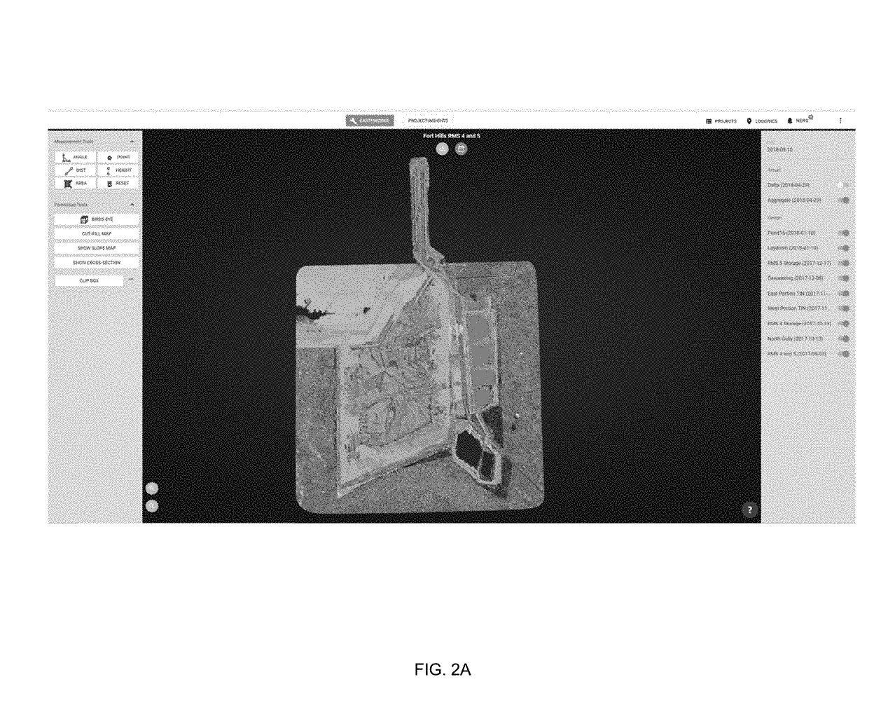

In view of the foregoing, it is desirable to provide an improved system to perform proof of work, identify mismatches, and track the progress of a large-scale construction project. Referring now to FIG. 1, shown therein is a block diagram of an automated digital twin model of truth (DTMT) system 100, also known as a digital execution verification system. As inputs, the DTMT system 100 receives plan data 104 and reality data 106 for a construction project from various data sources 102. DTMT system 100 models the reality data 106 into a digital twin of the construction site. The DTMT system 100 matches the digital twin to the project plan according to plan data 104, to perform proof of work, identify mismatches, and measure progress. Plan data 104 and reality data 106 are described in more detail below.

The digital twin permits a comparison of “what is” (i.e. physical reality) to “what you want” (i.e. the project design and schedule as specified by the planned data) and facilitates the generation of solutions to address mismatches between reality and planned data. In particular embodiments, the identification of mismatches between reality and planned data can be accomplished automatically by way of an automated digital verification engine. Early detection of mismatches allows construction-related issues to be resolved as they are discovered, preventing the compounding effects that can result in schedule slips, field fits, and rework.

The DTMT system 100 can be implemented as a software platform comprising various hardware and software components. The digital twin created or generated in the DTMT system 100 can be accessed in a number of ways including, but not limited to, by way of a web browser, streamed to the project designers or delivered as a digital file. The digital twin can be used by designers for front end engineering and design, by construction managers for proof of work and quality verification, and by project managers, project directors and executives for progress measurements and tracking. Visualization of the digital twin overlaid on top of its corresponding CAD model can also be provided, as described in greater detail subsequently.

In one implementation, the DTMT system 100 is hosted on a local or on-premises computer system (e.g. at the construction owner's offices) with hardware and software resources to facilitate local or remote access. The DTMT system 100 may alternately be hosted on a distributed or cloud-based environment located remotely at a data center (e.g. Google™ Cloud Services or Amazon™ Web Service). A cloud-based system may provide scalability in respect of storage memory or computational power. As the digital twin becomes more complex (e.g. as more of the reality data is being provided to the DTMT system 100), a cloud-based DTMT system may automatically allocate additional computing and/or storage resources to accommodate the more complex digital twin model.

Plan data 104 may include, but is not limited to, construction blueprints, construction scheduling, project schedules (e.g. Primavera P6 schedules), construction work package (CWP) information, budget information, and CAD models of various elements and structures of the construction conceived or developed during the project design and planning stages. Digital files corresponding to CAD models can vary depending on the CAD software used by the design team. These file formats include, but are not limited to, 3D Studio; ACIS SAT; AutoCAD; Bentley MicroStation (V7 DGN); Bentley MicroStation (V8 DGN); Catia; CIS/2; DWF/DWFx; FBX; IFC; IGES; Informatix MicroGDS Inventor; JT Open; MicroStation (SE, J, V8 & XM); Navisworks; NX; Parasolids; PDS Design Review; Pro/ENGINEER; Revit; Rhino; RVM; SketchUp; SmartPlant3D (.vue); Solidworks; STEP; STL; and VRML.

Reality data 106 is representative of actual construction project data. DTMT system 100 is operable to ingest (either periodically or continuously) reality data 106 captured from the construction site, fabrication yard, manufacturing facility or any other location in the construction project supply chain. Reality data 106 comprises one or more of the following:
spatial information such as earthworks data indicating the degree of modification or processing of the earth's surface associated with construction project;
facility data indicating the elements of the project that have been built and yet to be built; and
component data indicating the inventory and usage of various components needed in the construction project.

The above categories of reality data can take at least the following forms:
3D point cloud data acquired from a laser scanner
camera photos acquired from a person, tripod, unmanned aerial vehicle (ie. drone) or unmanned ground vehicle.
satellite imagery
360° images acquired from 360° cameras
RFID tag data read by RFID readers
   This data can be ingested, as described in greater detail below, and modelled into a digital twin corresponding to an accurate up-to-date representation of the physical asset (e.g. a construction component or the facility being built).
   File formats corresponding to reality data 106 include, but are not limited to, point cloud data (i.e. data corresponding to a 3D-scanned object) in the form of E57, LAS, PTX and other file formats, and geographic information systems (GIS) data in the form of ESRI™ Shapefile and Keyhold Markup Language (KML), for example.

The DTMT system 100 comprises a data ingestion module 110 which is configured to receive and process plan data 104 and reality data 106 obtained from data sources 102. According to particular embodiments, data ingestion module 110 is configured to handle data provided in any suitable raw and processed formats including in any one of the above-mentioned file formats. In some embodiments, the manner of data ingestion can be carried out according to a data capture execution plan that specifies a desired data capture frequency and accuracy based on project milestones, a fixed delimited timeline, or ad-hoc based on data generated from a surveyor. For example, the execution plan may be provided to the DTMT system 100 by a project manager via the user interface. The execution plan may be entered manually by way of using a customized user interface or by uploading an execution plan file in a machine readable form such as XML, JSON or any suitable public or proprietary file format. In one embodiment, the execution plan may instruct the DTMT system 100 to constantly ingest data related to the construction site as it is being built (i.e. constant digitization) allowing an interested party to measure progress and identify quality issues in near real time.

In some embodiments, the execution plan may further include a specification of the various data input elements available to the ingestion modules. For example, the execution plan may include access credentials to enable the data ingestion module to access electronic file repositories (e.g. for accessing CAD drawings in the various file formats, and the like) or contact certain data providers to acquire the desired plan data and/or reality data. For example, access credentials for satellite imaging providers can be included to enable the ingestion module to automatically download satellite images of the construction site. Additionally, the execution plan may further specify device IDs (e.g. in the form of MAC addresses, IP addresses, and the like) of sensor devices such as RFID readers, cameras, laser scanner systems and Light Detection and Ranging (LiDAR) systems that are installed at the construction site. The data ingestion module 110 may generate suitable control signals to trigger the capture of various data points as needed.

Data capture devices may further include semi-autonomous vehicles, such as drones and unmanned ground vehicles, having installed thereon the aforementioned sensor devices. These devices may be deployed remotely at the construction site and may be configured to respond to control signals generated by the data ingestion module 110 to capture the desired real data. Based on the information set out in the data capture execution plan, the data ingestion module 110 may generate such control signals for transmission to the data capture devices.

The foregoing example of data acquisition based on the execution plan is represented in FIG. 1 as being implemented through an automatic data ingestion component 112. Alternately, the data can be provided to the DTMT system 100 through manual input by a technician and uploaded to the DTMT system 100 using an interface. This is illustrated as manual input component 114 in FIG. 1. The interface for manual data input may take the form of a graphical user interface in which a user can upload the files corresponding to plan data 104 or reality data 106. The interface may be a software-based interface such as a File Transfer Protocol (FTP) gateway to receive data files or an application programming interface (API). The data ingestion module 110 can further be operable to generate reminders, such as, for example, by email, text messaging and the like to individuals such as the project manager to request for updated data. The acquired data may be processed and stored in a database for subsequent use. In some embodiments a combination of automatic data ingestion 112 and manual input 114 may be used, as some data may be automatically captured while other data is provided through manual input.

At least some data points received (e.g., corresponding to plan data and/or reality data) can be tagged with additional metadata information in a metadata field such as the time of acquisition, geo localization data (i.e. longitude, latitude, and elevation), data accuracy, and audit data including information indicating the device that acquired the data, its accuracy, and the individual or data capture execution plan that requested the acquisition. Since the data ingestion module can be operated to ingest data on an on-going basis, the use of metadata information enables production of an auditable data trail to allow for data version control using a suitable version control system.

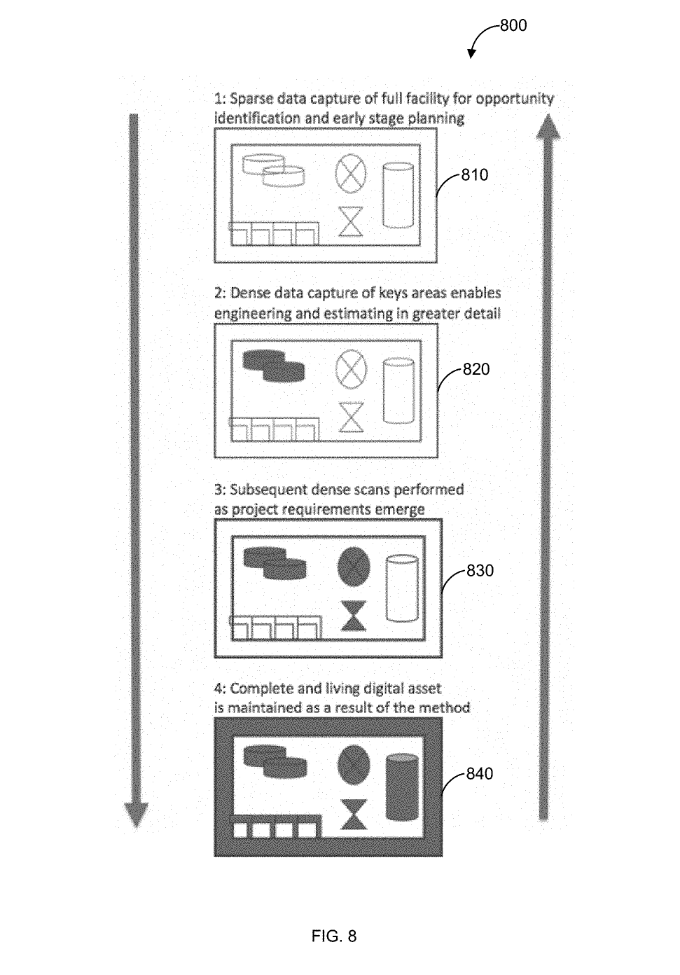

FIG. 8 illustrates an example of a data capture method 800 according to a data capture plan implemented by data ingestion module 110 of DTMT system 100. At step 810, a sparse data capture is carried out for the full facility (e.g. the entire construction site) to facilitate early stage planning and opportunity identification. Early stage planning can involve a detailed review of the construction project that is to be undertaken. This review helps identify critical areas of the construction site or construction process(es) with high uncertainty. This will then determine what data is required to help alleviate this uncertainty and risk. Some of this data may exist from prior scans or may be required for capture to help in early stage engineering design and planning. As the front-end engineering and design begins, at step 820, a dense data capture of key areas is carried out to enable engineering and estimating in greater detail. A dense data capture can also facilitate the reporting of true construction progress and verify that the quality of execution is within tolerance. As will be described in greater detail later, a dense data capture is used to generate a more precise digital twin to assist with identifying mismatches between construction plan and construction reality. As the construction of the project commences and various parts of the construction facility are being built, at step 830, subsequent dense scans and further sparse scans per step 810 are performed as additional project requirements emerge. For example, a contractor might be billing the owner for 60% of the contract value based on 60% of the scope of work being performed. The owner may want to perform a capture and verify both the quality of execution (i.e., that everything was installed in the right place) and the quantity of execution (i.e., that 60% of the actual construction has been performed).

These subsequent dense scans may be carried out for the same building structures located at the key areas noted and scanned at step 820 or for new key areas that have been identified for dense scanning. For example, a new area may be identified in the construction schedule or plan for the construction of a new structure at the construction site so that the new area can be identified as a new key area for dense scans. As shown in FIG. 8, as additional structures are scanned, these scanned structures become darkened to indicate that a dense scan has been carried out. At step 840, as additional areas of the construction site are covered by dense scans, a complete and living digital twin can be constructed and maintained by way of the scans. The steps of method 800 do not need to be carried out sequentially or in any particular order (as indicated by the two oppositely-pointed arrows in FIG. 8). For instance, sparse scanning at step 810 can continue to be carried out contemporaneously or sequentially for non-key areas as dense scans at steps 820 and 830 are carried out for key areas.

The complete living digital twin that has been acquired and maintained through the construction lifecycle creates a digital record of the asset that lives with the physical asset. This digital record can be used to support future potential claims, internal audits, compliance reviews and brownfield asset maintenance, shutdowns and turnarounds. As the physical asset reaches its end of life span, the digital record can support its decommission, deconstruction and remediation.

As described above, the data ingestion module 110 of the DTMT system 100 can be used to ingest captured reality data 106 corresponding to digitized parts of a construction project or the entire construction project. Once ingested, an infrastructure module 120 of the DTMT system 100 processes the ingested data into a usable form to allow integration of this data into the digital twin. Plan data 104 usually comes in a preprocessed usable format representing a plan model for ease of ingestion. The plan model includes components planned for construction (e.g., “planned components”). Reality data 106 is processed using object classification and segmentation algorithms to identify components including, but not limited to, earth, trees, pipes, steel, foundation, etc. to accurately compare reality to plans of individual components to identify errors and measure progress. In some embodiments, processing of the ingested data can further include classifying of the captured information to determine the type of data (e.g. plan data 104 or reality data 106), the type of representation (e.g. images, inventory data, geospatial data, and the like) and the context (e.g. earthworks information, facility information, component information and the like). Further granular classification can be carried out for more specific data types. For example, point cloud data generated by a 3D scanner can be classified on the basis of matching the data point to an object in a design saved within a CAD file.

In one configuration, the infrastructure module 120 is configured to provide a user interface to facilitate manual data classification. The interface may include at least one display portion indicating the ingested data and at least one display portion providing a list of classifiers for a user to associate with the ingested data. For example, the interface may allow the user to identify objects within an image corresponding to components of the project (e.g. pipes, walls, etc.) and to map those objects to a corresponding counterpart within a CAD file. Once this association is created, a tolerance threshold can be applied by the project manager or project controls team to identify all components which have been installed within tolerance, installed out of tolerance, or not installed. More specifically, an out of tolerance mismatch can be regarded as a quality issue which may affect the calculation of construction progress. For example, if a re-installation is required to address the mismatch, the time required to conduct this re-installation should be considered and may affect the progress by causing a decrease in the percentage progress.

In other configurations, the described classification process can be carried out automatically using a machine learning (ML) system to automatically carry out the segmentation and classification of individual components and commodities within the ingested data, such as point cloud datasets. For example, computer vision techniques can be applied to segment and classify objects within a point cloud gathered and link these objects to a corresponding CAD object in a CAD file. Previously ingested data and manually classified data can be used as training data so as to enable the computer system to automatically carry out these procedures with new data provided by the data ingestion module 110. The training data enables the DTMT system 100 to segment and classify components and parts from ingested data and further matching components and parts detected at the construction site spatially together with the corresponding components and parts specified in the design, thereby enabling a “plan vs. reality” to identify for mismatches.

Neural networks such as convolutional neural networks can be applied to process these datasets. Cloud-based computing services such as Google™ Machine-Learning-as-a-Service can be leveraged as well as open source frameworks such as TensorFlow™. The quality of object classification can be compared against recognized industry benchmarks such as the ImageNet Large Scale Visual Recognition Challenge, and existing status quo software such as Verity from ClearEdge™.

In other embodiments, a “human-in-the-loop” (HITL) technique can be used to accelerate the automation of segmentation and classification operations. These techniques operate by having persons who are not technical experts but who have application domain expertise to verify the correctness of the output of the segmentation and classification operations. The feedback provided by these persons can be translated into a signal or indicator that can be used to further refine the ML implementation without the need of a machine learning technical expert. In certain embodiments, these feedback mechanisms will be built into the features used by users on a regular basis.

Once the ingested data is processed, objects identified in the reality data can be linked to its counterpart in the design plan and associated documentation. Linking this information to the reality data captured from the construction site provides the foundation for automated proof of work, contractor payments and progress monitoring.

The linked plan and reality data information can then be used to generate a digital twin and establish a counterpart plan model of the construction project built in a virtual environment. In some embodiments, the ingested plan data already corresponds to a plan model or design plan (e.g., CAD files provided in AutoCAD and Navisworks formats, and P6 Schedules provided in Oracle Primavera formats) enabling that plan model to be established in the virtual environment, rather than having to generate the plan model. The ingested reality data can be used to generate the digital twin, which is a model of the most accurate and recent representation of the construction site. This digital twin can then be overlaid with the construction design as represented by the plan data (i.e., the plan model) and to digitally verify whether the real world construction matches the design. If the digital twin and the plan data do not match each other in the virtual world, then mismatches are automatically identified, as described in greater detail below. These mismatches may then be rectified by the project team.

In one implementation of the DTMT system 100, digital execution verification can be carried out using a calibration model that determines which data points to use in the aggregate based on frequency and accuracy. When stitching multiple data from multiple sources (i.e., satellite imagery, drone imagery and photogrammetry, and laser scans), multiple data sets can conflict each other based on accuracy. Satellite imagery may be the most comprehensive, capturing a large area down to a maximum accuracy of 15 cm (although most high fidelity satellite images produce ˜50 cm imagery). Drone photographs capture relatively less area but with 3-5 cm of accuracy. Finally, laser scans or LiDAR capture the least amount of area per scan but with higher density down to millimetre accuracy. The calibration model uses a mathematical algorithm to assign weightings to timeliness and accuracy of the data. In one implementation, the algorithm can dictate that if no drone and LiDAR data exists, then the satellite data is used as the baseline. If satellite data and drone data exists, then the drone data is used, unless satellite data has been acquired more recently within a specified standard deviation to account for the difference in accuracy. Finally, if laser data and drone data exists, then laser data is used for sensitive area(s) where quality is important (i.e., at tie ins) and the drone data is used for sparse capture to accurately assess progress. The foregoing approach therefore enables the DTMT system 100 to verify the quality of ingested data across datasets representative of the same geospatial areas, but obtained using different capture methods. For example, a standardized data capture method such as satellite data can be used to provide a “health check” on non-standardized terrestrial laser scans which will likely be different from site to site. This selection of data according to the calibration model forms the basis for constructing the digital twin.

This model would then be overlaid onto the Computer Aided Design (CAD)/Building Information Modelling (BIM) to identify any deviances and measure construction progress. This way, issues such as mismatches or construction inaccuracies may be addressed as they occur. Timely identification of issues can reduce the total cost of construction and reduce the construction time by resolving issues early in the construction cycle where they are relatively easy and inexpensive to fix.

In some embodiments, the data overlay procedure takes into consideration the geographical referencing or geo-localizing information provided in the metadata to calculate a position in the virtual environment in which the CAD model elements are also placed. The data points as discussed above are classified to enable association of a data point to a construction component/element used in the construction project, thereby enabling positioning of a digital version of construction component/element within the virtual environment. The digitized construction component is positioned in spatial relation to the corresponding CAD component since the positioning is determined based on the actual geographical references. In one embodiment, both reality and plan data include geo-location data in a meta data field. The geo-location information of the reality data refers to the location at which the reality data was captured, while the geo-location information of the plan data corresponds to planned location of the component/structure represented by that plan data. One set of data (e.g., the reality data) can be overlaid on the other set of data (e.g. the plan data) by placing both sets of data on the same geo-coordinate grid laid out within the virtual environment. In another embodiment, the reality data can be captured from a manufacturing facility or fabrication yard, rather than the construction site (e.g., data corresponding to components or parts that have not yet been installed). In this case, geo-location information can be applied to this reality data by registering the data to the coordinate system of the plan data to enable the reality data to be overlaid in the same geo-coordinate grid with the plan data. For example, during the overlay, a construction component that is built and installed according to specification would have geo-localizing information that would cause its digitized version to occupy the same position in the virtual environment as its corresponding CAD counterpart. However if that construction component was not built to specification, the geo-localization information would cause the digital representation of the construction component to be positioned, relative the corresponding CAD counterpart, so that they do not occupy the same position in the virtual environment to indicate a mismatch between what is planned is what is built. Therefore the use of geo-localizing data provides “true” representation of the physical construction site in the digital environment in spatial relation to the corresponding CAD model to enable comparison of the two representations to identify mismatches and determine the progress of a project. The overlay process, as described in greater detail below, can include determination of a “ground truth” for the ingested data, a determination of the coordinate system and reference points of the data set, and “tying” datasets to the ground truth using techniques such as least squares analysis or any other suitable optimization strategy to minimize uncertainty.

For the purposes of the present disclosure, the “ground truth” can be defined as the “true” elevation of a location on Earth that can be obtained from a system that is known to be more reliable (i.e. a trusted device), more accepted by industry, or known to be more accurate. Any data (e.g. images) collected by remote sensing generally requires a ground truth. In other words, remotely captured data needs to be given a correct elevation from a trusted source. The truth, in the context of an image for example, is the relation between an image pixel, its content, and the location on the ground. For instance, take the case of a drone that is operated to fly over a construction site to acquire a series of images. The true ground may be determined for each individual pixel of a satellite image given that the image can span across a relatively large geographical region in which the elevation may vary. The drone's internal GPS location device is generally capable of providing only an estimate of the drone's height and therefore, an estimate of the Earth's elevation below. On the other hand, it is desirable that the data be “tied” to the “true ground”. The uncertainty of the GPS location coordinates obtained by the drone is often due to a variety of factors including satellite availability, signal quality, and sensor quality. For example, a hand-held GPS device can derive a horizontal position accurate to about 1 m, but the vertical position can be somewhere between 3 m to 10 m of the actual ground. If an individual with the hand-held GPS is standing at an elevation of 1000 m, the GPS device may show 1003 m instead. While this difference may not be a problem navigating around a city, this type of error/uncertainty could have significant implications if the GPS data is used to calculate the volumes in a mine. For example, such imprecision would lead to inaccurate estimates that may lead to under-budgeting or under-planning.

To address the uncertainty of the measured height, the drone is also flown over a high-quality GPS receiver system mounted on a survey monument with an established, trustworthy position (e.g. a trusted device). The survey monument is selected from the drone data to be established as a control point. By flying over the survey monument, the known coordinates of the trusted survey monument can be linked to the image data captured by the same drone to enable derivation of the ground truth for the image data.

Next, the coordinate system of the data can be determined. In some datasets, Cartesian or X, Y, Z coordinates may be used. In other applications geodetic coordinates may be used. The latter coordinate system may be used, for example, in GPS data. Elevation data based on certain coordinate systems may require correction to obtain a more accurate determination. For example, a GPS unit returns geodetic elevations in the geodetic coordinate system, which are mathematical constructs based on an ellipsoid earth model (i.e. earth being ellipsoidal shape). In reality, the shape of the earth is neither spherical, ellipsoid nor a flat disk. Rather, the Earth is more “potato” shaped. Furthermore, due to the influence of surface and subsurface geological formations, the gravity plumb vector (i.e., the line that an object follows as it falls toward the ground) can differ from the normal vector of the Z geodetic axis. As such, the geoid model is a more suitable mathematical model of the earth. For instance, in Alberta, Canada the difference between geodetic model and geoid model is about 20 m. As such, geoid model elevations may be applied to make corrections to geodetic elevations recorded in the field using the geodetic coordinate system.

As the data ingestion module 110 continuously provides updated data (e.g. reality data 106 and also plan data 104 as construction plans may be updated as needed) based on the data capture execution plan and provided to the infrastructure module 120, construction issues can be identified as they occur to improve cost and schedule certainty, by creating a constant feedback loop between on-site execution and project management. This feedback loop provides the project management team insights and to take actions required to avoid and mitigate issues identified in the DTMT system 100. This feedback can also be vetted by industry experts prior to execution. The industry expert's input intelligence can be fed back into the DTMT system 100 as training data for its Al engine to learn from and improve on future analysis.

In contrast, the current state of the industry generally involves relying on outdated “as-builts” for engineering and design. Sometimes a laser scan may be performed and integrated into the CAD design. However, as previously noted, this CAD model typically resides locally on the designer's computer, creating limitations to who can use and access it. Additionally, existing systems lack automated recognition, reporting and rectification insights for the engineer based on clashes found between the design and the digitized physical reality.

Referring to FIG. 1, the infrastructure module 120 further includes various tools that enable the project manager to use the digital twin to identify issues based on the ingested construction data. These tools can be classified as feature-based tools 122 and analytics-based tools 124. Feature-based tools allow users to interact with the data. This includes multi-user collaboration, measurement, annotations, volumetric comparisons of plans to reality, data toggles, time line toggle, slider, etc. Analytics-based tools 124 are operative to aggregate ingested data to generate insight from the data to identify quality issues (e.g., out-of-tolerance mismatches) and measure true construction progress. Using historical issue logs and construction progress measurements, the infrastructure module 120 can then forecast completion dates. In some cases, the accuracy of the forecast completion dates can be improved by applying techniques such as probabilistic graphical modelling and multi-agent simulations. The same techniques can further be used to forecast project progress, so that the DTMT system 110 not only answers the question “when will this project likely finish”, but also “what is the likely progress until the likely project completion date?” In some embodiments, the feature-based tools 122 and analytics-based tools 124 are providable through the DTMT interface available on a web browser, mobile, and/or virtual reality. These tools together provide the necessary data to enable the visualization module 130 to generate various visualizations of the digital twin including S-Curves, progress report tables, 2D visualizations 132, 3D visualizations 134, and virtual reality (VR) 136 visualizations. Other outputs of the visualization module 130 include bill of quantity (BOQ) reconciliation, daily report generator, project auditing and proof of progress.

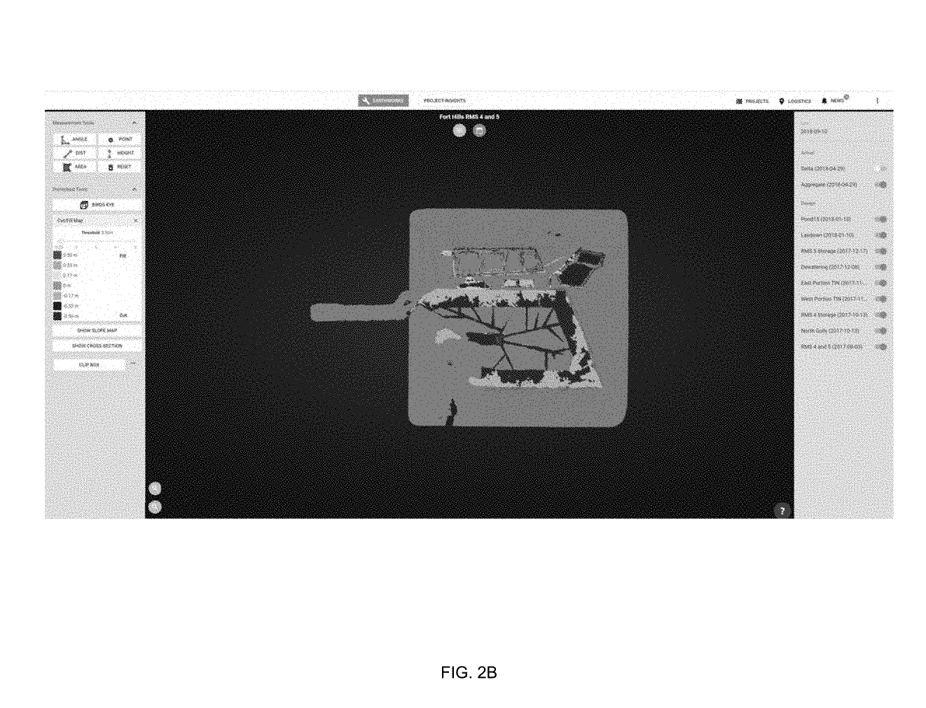

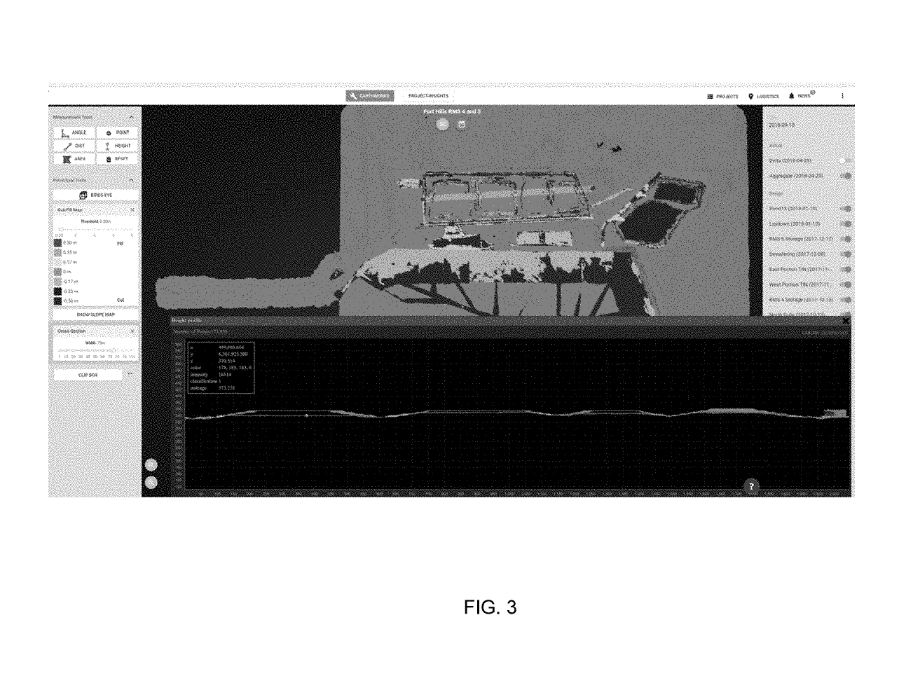

For example, using the features and analytics tools 120 and 124, a user such as a project manager can use the ingested data to generate a point cloud and CAD overlay using the visualization module 130, as shown in FIG. 2A. However such visualization may not be sufficient to provide the desired insight. For example, large industrial projects often have a significant civil earthworks component where massive quantities of soil is excavated to reconfigure the topography, stabilize slopes, construct tailings ponds, or construct run off the river hydro dams. In some cases the earth moving component can span multiple square kilometers of land area. Earthworks data obtained using information acquired by aircrafts, drones or satellite imagery can be included in the digital twin. As a result, a cut-and-fill heat map, as shown in FIG. 2B, using earthworks data with set threshold values to identify locations on the same construction site as shown in FIG. 2A can be generated to determine which location of the construction site to remove or add dirt/earth to adhere to the project plan. Alternatively, a civil slope grade heatmap can be generated instead for visualization.

Additionally, the earthworks data can be cross referenced with data containing geological models and environmental data to identify quantities of earth being moved, including by soil types. For example, time-based geo-referenced imaging combined with geological information may be used to determine the type of soil being moved by comparing images before the soil is moved and after the soil is moved. Discrimination by soil type is useful because contractor payments are often based on soil type unit rate where different types of soil (sand, clay, silt, rock, etc.) have different unit rates (e.g., sand: $3/m³, clay: $5/m³). This method of volumetric analysis and visualization can therefore provide more accurate contractor payments and invoicing for particular activities carried out in the construction project.

In another example, the overlaid data can be used to generate a civil cross section, as shown in FIG. 3, to measure differences between construction plans and actual constructed elements along a plane. For example, this cross section helps to show how much earth needs to be removed in order to achieve the final grade as per the design.

Tracking the progress of a construction progress is often an important quantifier to consider for high-value industrial projects. Generally, progress can be measured using a “percentage complete” or “percentage progress” method, for instance, by identifying components which have been correctly installed within tolerance. In some cases, a project manager and may or may not include components installed out-of-tolerance, for example, depending on the manager's view whether these out-of-tolerance installations are of the type that requires re-installation. Progress and quality reports can be generated as described in greater detail subsequently. A project plan/schedule is often established to set out the desired progress of the project. This plan/schedule can be located within or linked to the DTMT system 100 so as to enable the system to provide the planned progress of a construction site, and progress of fabrication of a pre-fabricated component at an assembly yard. The plan/schedule can further include planned percentage of completion by discipline (e.g. Civil, Structural, Mechanical, Piping, Electrical etc.) or by commodity (e.g. earthworks, amount of steel used, amount of piping installed, etc.). The digital twin may be analyzed by the DTMT system 100 against the CAD model to automatically determine an actual percentage of completion. The planned percentage completion may also be extracted from the schedule/plan to allow the DTMT system 100 to compare actual completion with the planned completion to determine whether the construction project is on schedule.

As described in more detail below, the DTMT system 100 can output a report identifying the discrepancies between what should be built and what is built. The report may also provide an overall progress report showing earned progress (percentage completion) by discipline vs actual progress (percentage completion). A Schedule Performance Index (SPI) may also be provided indicating if the progress is behind schedule, on schedule or ahead of schedule. This may provide informational insight to analyze if the project is progressing as per the scheduled plan. The report may provide recommendations on what the focus could be targeted to mitigate any lack of progress. The recommendations can be analyzed and vetted by human experts and feedback can be provided to the DTMT system 100 to continually improve future reports based on expert feedback.

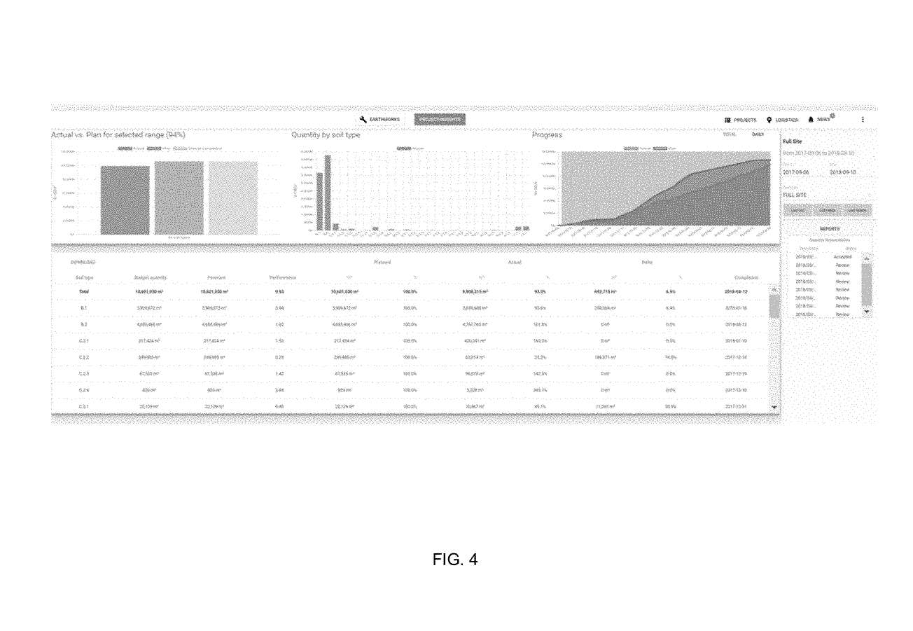

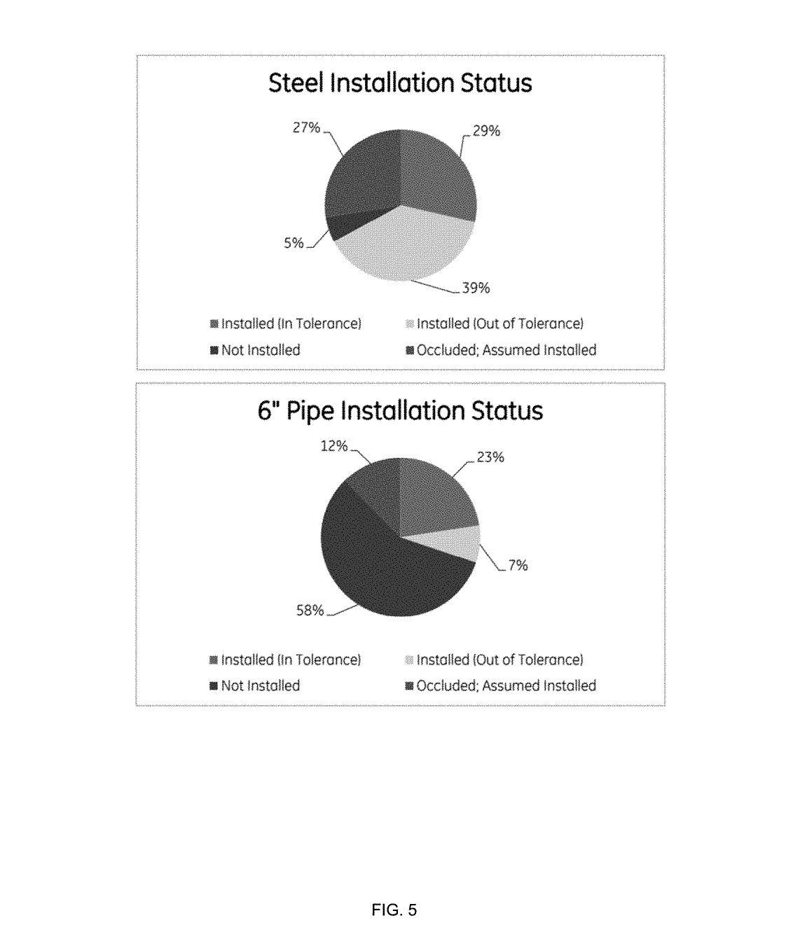

A report of the progress of the construction project can be expressed as a 2D Bill of Quantities (BOQ) report that counts the type and quantities of material used. For example components of construction used, including earthworks (based on soil types), concrete, structure steel and piping, can be listed as shown in FIG. 4 to show a measure of planned utilization and actual utilization. A corresponding chart as shown in FIG. 5 and illustrates a comparison of actual BOQ to project plans, shown as the CAD and scheduled milestone to identify a percentage of completion of the total product (reality data compared to the CAD alone) and percentage completed of project milestones (reality data compared against CAD and Schedule). The analytics can also generate a Schedule Performance Index to indicate if the project is behind schedule, on schedule, or ahead of schedule based on the reality data.

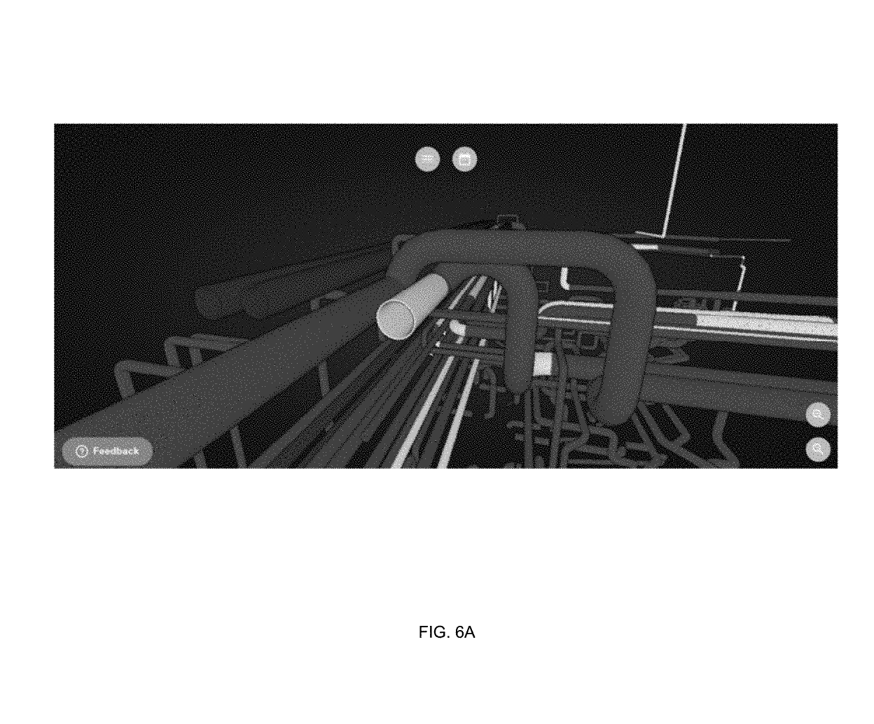

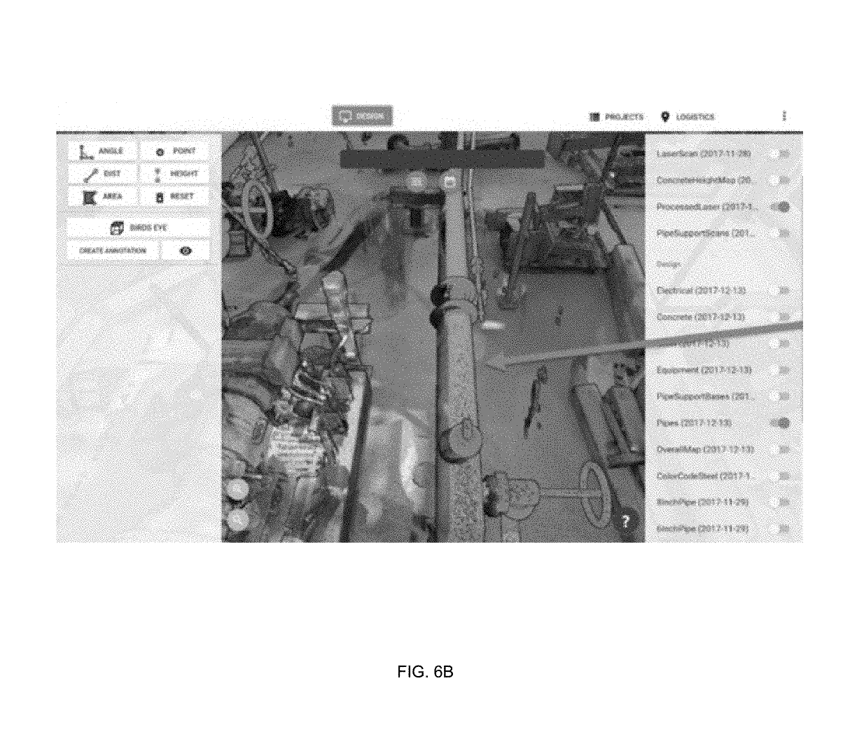

In another implementation, the construction progress can be visualized in 3D, as shown in FIG. 6A, using the CAD model in which components that have been installed within tolerance are identified using a first colour (e.g., green) while components that have not been installed (e.g. a missing component mismatch) can be identified by a second colour (e.g., red). The same components can alternatively be visualized as a 3D heat-map indicating installed or uninstalled elements as shown in FIG. 6B.

The DTMT system 100 can provide further granularity in tracking progress given the higher cost of large infrastructure projects. Consider the construction of a refinery, for example. It is generally not enough to just know whether a pipe is in the right or wrong place or whether it is installed. If a pipe is in the wrong place, the project owner and contractor must know by how many millimeters is the surface of the pipe tie-in (end of the pipe) off, and by what angle. Even if the pipe is in the right place, and fits at both ends, they must know if the pipe was bent in the middle by the pipe-fitter in order to fit at both ends—more specifically, by what angle was it bent, and what is the volumetric impact. In another scenario, suppose the pipe has been perfectly placed, but it may be the wrong pipe—i.e. 16.5 cm (6.5 inches) versus 16 cm (6.3 inches), which can be a significant difference when dealing with chemical processes.

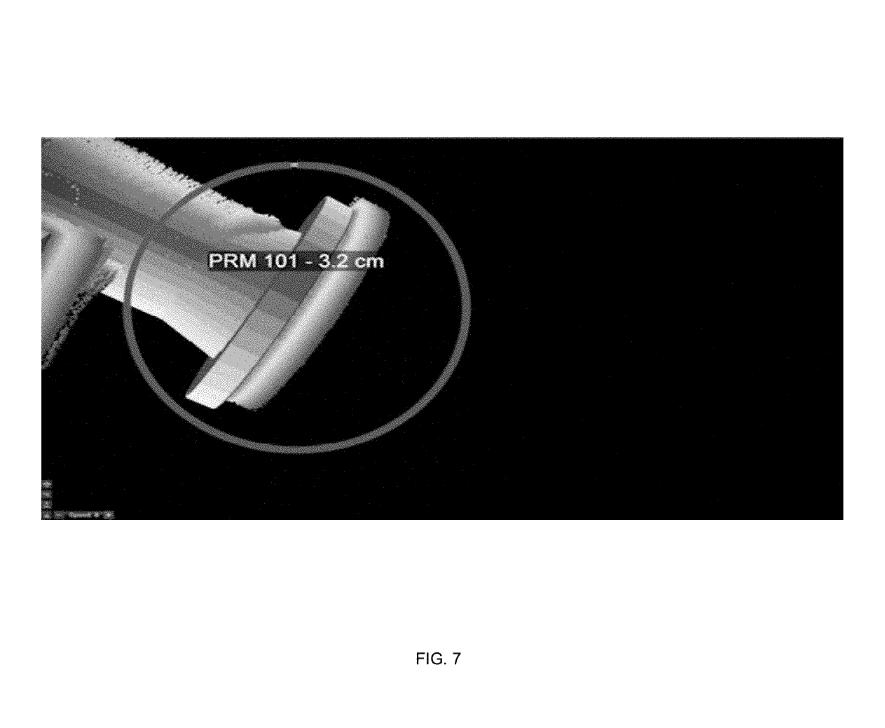

To provide the level of granularity desired, the DTMT system 100 is configurable to generate a third indicator using a third colour (e.g., yellow). This indicator may be used to identify components that have been installed, but fall outside of specified tolerance levels, indicating a clash or out-of-tolerance mismatch. The mismatch can be calculated by considering the degree of overlap between measured positions of an installed component represented by reality data relative to its expected position represented by the plan data. The degree of mismatch can be further visualized as shown in FIG. 7, to indicate the degree of mismatch of the installed component using the geo-spatial information obtained at the time of data acquisition so as to enable improved accuracy of the overlay of reality data with plan data. These mismatched or clashing components can be flagged so that the component can be adjusted or re-installed to fall within the specified tolerance levels. In particular embodiments, a user is presented with suggested actions required to address the mismatch and to ensure the component would fit into the existing constructed facility. The infrastructure module can therefore provide clash detection by flagging issues to the project manager or project management team. As noted previously, manually generated progress reports are often based on determining whether an element or component was installed or not by way of a manual progress survey. It can be appreciated that this method has limitations because it would not be able to identify components which have been incorrectly installed, which should also be recorded in the progress measurement. The DTMT system 100 as described herein is operable to identify whether a component was installed, not installed, or installed but out of tolerance. Using one or more pieces of this information (e.g. installation status and/or out-of-tolerance indicators), the DTMT system 100 provides a more accurate progress report of the percentage completed.

In some embodiments, the DTMT system 100 is further configurable to generate an issues report outlining the identified mismatches. A user requesting the issues report can optionally request the report to include suggested actions required to address the mismatch and to ensure the component would fit into the existing constructed facility. The issues report may be analyzed by relevant human experts and vetted. The issues and proposed actions as vetted by the experts can be fed back into the DTMT system 100 and submitted to relevant responsible action groups, to facilitate one or more of the following outcomes/responses: modify the design (e.g. the CAD models) by parties responsible for engineering; modify the fabrication (e.g. of the pre-fabricated components) by the parties responsible for fabrication work; modify the construction by parties responsible for construction work; and modify relevant assembled part by parties responsible for assembly work. The outcome is fed back into the DTMT system 100 to improve machine-learning components to output improved reports going forward based on industry expert inputs.

As shown in the various visualizations available, the DTMT system 100 further allows assembly simulation using the reality data to virtually simulate the assembly of pre-fabricated modules that have been digitized to ensure that each element will fit when these modules arrive at the construction site. As noted previously, industrial capital projects involve using parts and equipment being manufactured all around the world. As such, the data ingestion module enables the suppliers of the various pre-fabricated modules to each submit module data, measured using a 3D laser scanner, for example, to the DTMT system 100 as they are being fabricated. Regardless of where the suppliers are located, the data can be submitted electronically so that a trial-fit as described previously can be carried out virtually. This approach provides a quality control/quality assurance system to ensure that all fabricated parts will fit when they arrive at the physical construction site. For the supplier, such quality control helps support decisions such as “should I ship my module or not?”, thereby reducing the likelihood additional time and expense associated with rework to correct for mismatches.

In some embodiments, the DTMT system 100 further provides logistics services to minimize delays with respect to provision of components and the relevant tools, personnel, vehicles, transport systems, construction equipment, parts, components, sub-structures needed (i.e. construction resources) for the construction project by tracking their locations and availabilities. In other words the logistics services can be used to address requirements with respect to providing the necessary parts and tools at the correct location as they are needed, and where these tools/parts are located at any given time (e.g. in real-time). To provide logistics services, location data of the tracked elements are determined and recorded. To do so, sensors can be placed on the tools and components/parts of the construction projects. The sensors can be scanned to determine their locations. For example, RFID tags or connected devices such as Internet of Things (IoT) devices operable to report its position to the DTMT system 100. Alternatively, RFID tags may be scanned by scanners positioned at known locations throughout the construction site or active RFID and the scanned data indicating their location is then relayed to the DTMT in real-time. Communications with the DTMT system 100 can be facilitated using various methods including, but not limited to, satellite, Wi-Fi, cellular communication, on-site gateways, and manual readers.

The availability of a resource can be determined based on the location of the resource. For example, if a tool is located within a designated storage area, it is likely that the tool is available for use. The same tool may not be available for use if its location is determined to be within an area designated as a construction site. Other types of sensors that are capable of identifying further information about a construction resource can be incorporated. For example, power sensors can be deployed to identify the on/off status of tool or machine. Accelerometers can be positioned within a tool or machine to determine whether it is in motion (i.e. likely to be in use) or idle (likely not in use). The outputs of these sensors can be measured in respect of a particular time point or over a time interval to ascertain its availability. Combining the outputs of various sensors can therefore provide more robust determinations of the availability of a resource.

The logistics services of the DTMT system 100 is linked to or includes a project plan/schedule. The plan may include the construction work package (CWP) attributes that may provide information such as when or where the particular parts/components is to be built/assembled, and provide an identifier to link a CWP to a materials management database. The CWP can further be configured to specify the types of tools and equipment required for the work carried out at the construction project.

A materials management database (MMD) may reside within or may be linked to the DTMT system 100. The MMD may list the parts and tools specified by the CWP as well as the unique identifiers of the parts and tools. These unique identifiers link the parts and tools to an IoT/RFID/GPS identifier and to a construction project plan/schedule.

Based on the construction project plan/schedule, the DTMT system 100 may know where and when tools and parts are required and using the logistics services, verifies that they are at the desired locations when needed. The DTMT system 100 compares the planned location to the actual location (as provided by the logistics service) and generates a corresponding issues and action report identifying any mismatches. The report can be analyzed and vetted by human experts to provide feedback to the DTMT system 100 so as to continually improve the reports going forward based on expert input.

The DTMT system 100 may also predict the required locations of the parts and tools before they are needed in a final location identifying any challenges before they affect the project. For example, the DTMT system 100 may determine that based on the construction project plan/schedule, a particular component requiring concrete is to be built two weeks away. Accordingly, the storage warehouse or concrete supplier may be notified to indicate that that additional concrete could be needed at a specific location because the existing supply at that location is insufficient. The logistics service is also operable to generate reports which advise if and when all required parts and tools are where they need to be to start a specific CWP, ensuring productivity of workers as they will have all that is needed to complete the job.

In some embodiments, the DTMT system 100 is operable to ingest drone based photo data from the construction site at a pre-determined frequency, for example, every 4 hours. Photogrammetry can be used to process the data, converting this data from a 2D image into a 3D point cloud. Once in a 3D format, it is then possible to compare and overlay it with acquired data with the CAD model. Similarly, it is also possible to cross-reference the acquired data with the geological and environmental data to create a soil type map on the 3D model. Every time a new scan is uploaded to the DTMT system 100 (i.e., every 4 hours), the DTMT system 100 can stitch the new scan data into the existing data “aggregate”. A volumetric analysis can then be performed, comparing the two scans, i.e., the most recent scan and last available, to determine how much earth was moved in the past 4 hours. This real-time audited report can be given to the project controls and accounts payable team to support the unit rate invoicing of the contractor. This report is also providable to the construction manager and project manager for real-time decision making. Under past practice, reports arrived every 14 days, resulting in decisions being made based on “gut instinct” and old information. Daily reporting would enable the project team to make decisions that optimize their process. For example, the increase in frequency in respect of progress reporting can enable construction managers to circumvent planned but unnecessary excavations, thus saving time and money.

Once the earthworks component of construction is complete, concrete will be poured to create the foundation of the facility or capital asset. A drone, applying the same method as above, can monitor how much concrete has been poured and provide a notification to the project team once the desired grade as per the CAD model has been achieved. If too much concrete has been poured, the DTMT system 100 would identify the excess concrete as an issue and report it to the project management team who can then decide whether they want to lower the grade by grinding and sanding the foundation or leave it as is. Suitability of both decisions can be based on the type of infrastructure and the remaining asset to be built on top of the foundation. A simulation could be performed assessing the financial implication of each possible decision.

Once the concrete is poured and all the civil components have been completed, mechanical construction will begin. Modules may be prefabricated in a fabrication yard. These modules could be digitized at multiple fabrication shops. Small errors of 1 cm in individual modules could be identified and deemed acceptable for the fabrication shop's individual scope of work. However, a constructability simulation tying in modules at the point of construction may identify that three small errors of 1 cm on the critical path of construction would result in a field weld at the point of construction. The DTMT system 100 could recognize that while two of these errors would not be a problem, the third error could create the need for a field weld. Instead of shipping the modules and performing the field weld at the point of construction, the project manager would ask one of the fabrication shops to perform a 1 cm field weld at the fabrication shop before shipping the module. Once the field weld is performed, a new simulation can be performed to verify and ensure that everything would fit at the construction site. Once this assurance is obtained, a notice would be sent to the fabrication shop to authorize shipment of the modules.

Meanwhile, as the modules are in transit, there is likely to be some stick-built construction taking place at the construction site. The owner may receive a progress report from his contractor saying they are 60% complete and within 3 weeks they will be 65% complete and ready to tie in the modules. A laser scan of the construction site would be conducted and the captured data can be analyzed by the DTMT system 100. Based on the data, the DTMT system 100 may identify that the contractor is truly 60% complete based on an absolute analysis of components installed. However, it may be possible that the DTMT system could also identify that 15% of these components are installed but out of tolerance (i.e. a mismatch). The primary issue is that the tie ins are 5 cm to the left of where they should be. This mismatch will make it difficult to tie in the modules which are currently in transit. The project manager directs the subcontractor to address the issue and shows the subcontractor the intolerance using the visualization engine. The subcontractor now knows she will not be able to meet the schedule requirement given current resources available because this newly identified issue must be resolved. Relying on the information provided by the DTMT system 100, she therefore hires 6 new sub-contractors to fix the mismatch in time for the modules' arrival, while allowing her current team to work on their planned scope of work.

The examples and corresponding diagrams used herein are for illustrative purposes only. Different configurations and terminology can be used without departing from the principles expressed herein.

Although the invention has been described with reference to certain specific embodiments, various modifications thereof will be apparent to those skilled in the art without departing from the scope of the invention. The scope of the claims should not be limited by the illustrative embodiments set forth in the examples, but should be given the broadest interpretation consistent with the description as a whole.

1. A system for managing a construction project comprising:
a communication interface;
a data ingestion module operable to receive data associated with the construction project from a plurality of data sources through the communication interface;
an infrastructure module operable to generate a digital twin of the construction project in a virtual environment using a first subset of the data, and establish a plan model of the construction project in the virtual environment using a second subset of the data; and
a display interface operable to display at least a portion of the digital twin overlaid with a corresponding portion of the plan model;
wherein the plan model contains at least one planned component, and the digital twin contains at least one construction component associated with a corresponding constructed component at one of a manufacturing facility, fabrication yard, and a construction site.

2. The system of claim 1, wherein the first subset of the data corresponds to construction site data acquired at the construction site, and the second subset of the data corresponds to project planning data.

3. The system of claim 2, wherein at least one data point of one of the first subset of the data and the second subset of the data contains geo-location data in a metadata field usable to determine a position of the at least one construction component within the virtual environment.

4. The system of claim 3, wherein the virtual environment comprises a geo-coordinate grid, and wherein the at least one data point is placed on the geo-coordinate according the geo-location data.

5. The system of claim 1, wherein the infrastructure module is further operable to determine a ground truth of the ingested data based on at least one image obtained of a survey monument having known coordinates.

6. The system of claim 1, wherein a construction mismatch is determinable based on a comparison of the digital twin and the plan model in the virtual environment, wherein the construction mismatch constitutes at least one of a missing component mismatch and an out-of-tolerance mismatch.

7. The system of claim 1, wherein the display interface is configurable to display at least one of the digital twin, plan model, and overlay of the digital twin and plan model in at least one of a two-dimensional display mode, three-dimensional display mode, and a virtual reality display mode.

8. The system of claim 1, wherein the first subset of data contains geo-location data in a metadata field and the system further comprises a logistics service module to maintain a record to track the location and availability of at least one of tools, personnel, vehicles, transport systems, construction equipment, parts, components, sub-structures required for the construction project based on geo-location data contained in a metadata field of the first subset of the data.

9. The system of claim 6, wherein the infrastructure module is further operable to generate a progress report that indicates the extent of completion of the construction project based on at least one of the missing component mismatch and out-of-tolerance mismatch.

10. A method to manage a construction project comprising:
receiving data associated with the construction project from a plurality of data sources;
generating a digital twin of the construction project in a virtual environment using a first subset of the data, the digital twin containing at least one construction component associated with a corresponding constructed component at one of a manufacturing facility, fabrication yard, and a construction site;
establishing a plan model of the construction project in the virtual environment using a second subset of the data, the plan model containing at least one planned component; and
overlaying at least a portion of the digital twin on to the plan model in the virtual environment.

11. The method of claim 10, wherein the first subset of the data corresponds to construction site data acquired at one of the construction site, fabrication yard, and manufacturing facility, and the second subset of the data corresponds to project planning data.

12. The method of claim 11, wherein at least one data point of one of the first subset of the data and the second subset of the data contains geo-location data in a metadata field usable to determine a position within the virtual environment for the digital twin.

13. The method of claim 12, wherein the virtual environment comprises a geo-coordinate grid, and wherein the overlaying comprises placing the at least one data point is on the geo-coordinate according the geo-location data.

14. The method of claim 12, wherein the overlaying the digital twin on the plan model comprises positioning the at least one construction component in spatial relation to a counterpart planned component of the at least one planned component within the virtual environment, the spatial relation being determinable based on the geo-location data associated with a physical location of the corresponding constructed component at the construction site.

15. The method of claim 10 comprising determining a ground truth of the data based on at least one image obtained of a survey monument having known coordinates and adjusting the geo-location data based on the ground truth.

16. The method of claim 10 comprising identifying construction mismatches by comparing the digital twin and the plan model in the virtual environment, wherein the construction mismatches constitutes at least one of a missing component mismatch and an out-of-tolerance mismatch.

17. The method of claim 10 comprising maintaining a record to track the location and availability of at least one of tools, personnel, vehicles, transport systems, construction equipment, parts, components, sub-structures required for the construction project based on geo-location data contained in a metadata field of the first subset of the data.

18. The method of claim 16 comprising generating a progress report that indicates the extent of completion of the construction project based on at least one of the missing component mismatch and out-of-tolerance mismatch.
